(19) United States
(12) Patent Application Publication
(10) Pub. No.: US 2023/0113757 A1
(43) Pub. Date: Apr. 13, 2023

(54) DISPLAY CONTROL INTEGRATED CIRCUIT APPLICABLE TO PERFORMING REAL-TIME VIDEO CONTENT TEXT DETECTION AND SPEECH AUTOMATIC GENERATION IN DISPLAY DEVICE

(71) Applicant: Realtek Semiconductor Corp., HsinChu (TW)

(72) Inventors: Kuan-Ting Chiang, HsinChu (TW); Chun-Chieh Chan, HsinChu (TW); Sheng-Ju Yang, HsinChu (TW)

(73) Assignee: Realtek Semiconductor Corp., HsinChu (TW)

(21) Appl. No.: 17/540,200

(22) Filed: Dec. 1, 2021

(30) Foreign Application Priority Data
Oct. 7, 2021 (TW) 110137354

(51) Int. Cl. G10L 13/08; G06V 30/18; G10L 13/04; G06V 30/164; G06V 20/40; G06V 30/148; G06V 30/26; G06V 20/62; G06V 30/12; G06V 30/19

(52) U.S. Cl. CPC G10L 13/08; G06V 30/18019; G10L 13/04; G06V 30/164; G06V 20/46; G06V 30/148; G06V 30/26; G06V 20/635; G06V 30/133; G06V 30/19093

(57) ABSTRACT

A display control integrated circuit (IC) applicable to performing real-time video content text detection and speech automatic generation in a display device may include a pre-processing circuit, a character recognition circuit and a post-processing circuit. The pre-processing circuit may input a video signal to obtain a real-time video content carried by the video signal, and perform preliminary text detection on the real-time video content to generate a series of segmented character images to indicate a subtitle. The character recognition circuit may perform character recognition on the series of segmented character images to generate a series of characters, respectively. The post-processing circuit may perform vocabulary correction on the series of characters to selectively replace any erroneous character with a correct character to generate one or more vocabularies, for performing speech automatic generation.

### BACKGROUND OF THE INVENTION

### 1. Field of the Invention

The present invention relates to display control, and more particularly, to a display control integrated circuit (IC) applicable to performing real-time video content text detection and speech automatic generation in a display device.

### 2. Description of the Prior Art

According to the related art, an image-to-speech conversion system can generate human-understandable sounds to help people in need, and can be implemented with a learning-based conversion architecture, for example, through various neural network training. The recognition result of the learning-based conversion architecture can be very accurate, but some problems may occur. For example, the time complexity and space complexity of the calculations performed by the learning-based conversion architecture during the recognition are extremely high, which increases the time required for the recognition. Thus, a novel method and associated architecture are needed for realizing a compact, fast and reliable image-to-speech conversion system without introducing any side effect or in a way that is less likely to introduce a side effect.

### SUMMARY OF THE INVENTION

It is therefore an objective of the present invention to provide a display control integrated circuit applicable to performing real-time video content text detection and speech automatic generation in a display device, in order to solve the above-mentioned problems.

It is another objective of the present invention to provide a display control integrated circuit applicable to performing real-time video content text detection and speech automatic generation in a display device, to configure the display device to be a compact, fast and reliable image-to-speech conversion system.

At least one embodiment of the present invention provides a display control integrated circuit (IC), where the display control IC is applicable to performing real-time video content text detection and speech automatic generation in a display device. The display control IC may comprises: a pre-processing circuit, configured to input a video signal to obtain a real-time video content carried by the video signal, and perform preliminary text detection on the real-time video content to generate a series of segmented character images to indicate a subtitle; a character recognition circuit, coupled to the pre-processing circuit, configured to perform character recognition on the series of segmented character images to generate a series of characters corresponding to the subtitle, respectively; and a post-processing circuit, coupled to the character recognition circuit, configured to perform vocabulary correction on the series of characters to selectively replace any erroneous character with a correct character to generate one or more vocabularies, for performing speech automatic generation.

One of the advantages of the present invention is that through the carefully designed display control and additional processing mechanism, the display control integrated circuit of the present invention can perform real-time text detection on the image content during video display to automatically generate subtitle information for conversion into speech information for speech output. In addition, the display control integrated circuit of the present invention can provide a compact, fast and reliable image-to-speech conversion system, which can be implemented with a non-learning-based conversion architecture, where the time complexity and space complexity can be greatly reduced. In comparison with the related art, the display control integrated circuit of the present invention can realize a display device with image-to-speech conversion function without introducing any side effect or in away that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a display control integrated circuit (IC) applicable to performing real-time video content text detection and speech automatic generation in a display device according to an embodiment of the present invention.

FIG. 2 illustrates a real-time multi-processing control scheme of a method for performing real-time video content text detection and speech automatic generation in a display device such as the display device shown in FIG. 1 according to an embodiment of the present invention, wherein the method can be applied to the display device shown in FIG. 1 and the display control integrated circuit therein.

FIG. 3 illustrates an image filtering and target region control scheme of the method according to an embodiment of the present invention.

FIG. 4 illustrates a redundant-processing prevention control scheme of the method according to an embodiment of the present invention.

FIG. 5 illustrates a character image isolation/segmentation control scheme of the method according to an embodiment of the present invention.

FIG. 6 illustrates a character classification and recognition control scheme of the method according to an embodiment of the present invention.

FIG. 7 illustrates a vocabulary correction control scheme of the method according to an embodiment of the present invention.

FIG. 8 illustrates a pixel-based line and background detection control scheme of the method according to an embodiment of the present invention.

FIG. 9 illustrates a text image pre-processing control scheme of the method according to an embodiment of the present invention.

### DETAILED DESCRIPTION

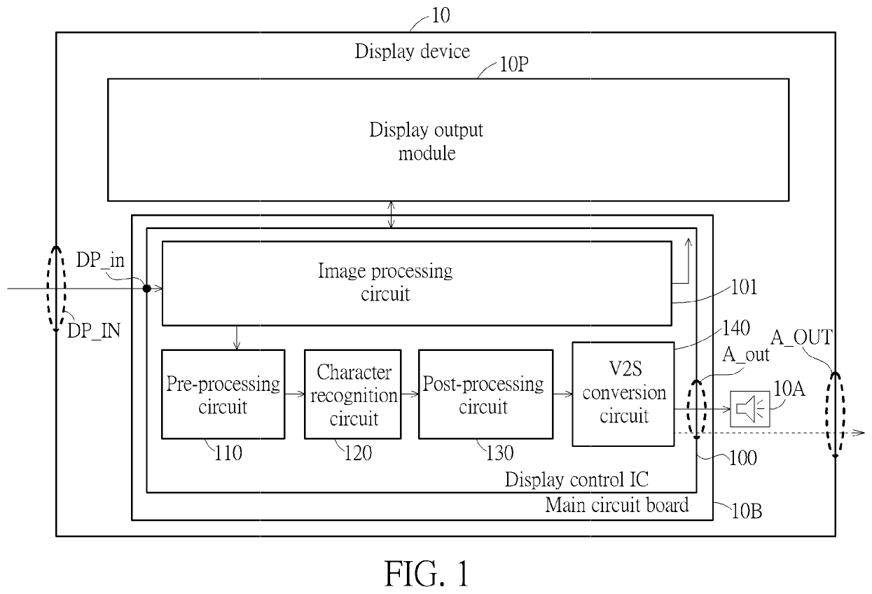

FIG. 1 is a diagram of a display control integrated circuit (IC) 100 applicable to performing real-time video content text detection and speech automatic generation in a display device 10 according to an embodiment of the present invention, where the display control IC 100 may be positioned in the display device 10, and more particularly, may be mounted on a main circuit board 10B (e.g., a printed circuit board) of the display device 10, but the present invention is not limited thereto. In some embodiments, the main circuit board 10B may be replaced by another circuit board in the display device 10, such as any circuit board of one or more secondary circuit boards.

The display device 10 may comprise a display output module 10P (e.g., a display panel such as a liquid crystal display (LCD) panel), the main circuit board 10B together with the display control IC 100 thereon, an audio output module 10A, a video input port DP IN and an audio output port A_OUT, and the display control IC 100 may comprise multiple terminals such as a video input terminal DP in and an audio output terminal A_out, and may comprise multiple sub-circuits such as an image processing circuit 101, a pre-processing circuit 110, a character recognition circuit 120, a post-processing circuit 130 and a vocabulary-to-speech (V2S) conversion circuit 140, where a control circuit (not shown in figure) in the image processing circuit 101 may control the multiple sub-circuits to control the operations of the display control IC 100. The display control IC 100 may comprise a storage unit to be one of the multiple sub-circuits, and some other sub-circuits among the multiple sub-circuits (e.g., the image processing circuit 101, the preprocessing circuit 110, the character recognition circuit 120, the post-processing circuit 130 and the V2S conversion circuit 140) can share the storage unit, where the storage unit may comprise at least one line buffer, but the present invention is not limited thereto. For example, the storage unit may be integrated into a certain sub-circuit of the multiple sub-circuits, such as any of the image processing circuit 101, the pre-processing circuit 110, etc.

In the architecture shown in FIG. 1, the main circuit board 10B (e.g., the display control IC 100 therein, and more particularly, the image processing circuit 101) can control the operations of the display device 10, and these operations may comprise but are not limited to:

(1) performing video pre-processing operations, such as stream conversion, video format conversion, etc.;
(2) performing image processing, such as image brightness adjustment, color temperature adjustment, etc.;
(3) performing display output control, and more particularly, generating associated display control signals to control the display output module 10P to display one or more pictures; and
(4) utilizing a user input device (e.g., one or more buttons) of the display device 10 to receive one or more user inputs of a user of the display device 10, and utilizing the display output module 10P to perform on-screen display (OSD) to guide the user to interact with the display device 10, for example, to guide the user to provide any of the one or more user inputs through the user input device; wherein, the display device 10 and the display control IC 100 therein may conform with one or more specific standards, such as the Display Port (DP) standard of the Video Electronics Standards Association (VESA), and an input video signal inputted by the display control IC 100 from a video source device through the video input port DP IN and the video input terminal DP_in may conform with a predetermined packet format such as a packet format of the DP standard, but the present invention is not limited thereto. In addition, the display control IC 100 (e.g., the control circuit) can selectively enable or disable the operation of at least one additional function of the display control IC 100, for example, in response to the any of the one or more user inputs. The associated operations of the at least one additional function may comprise operations of the pre-processing circuit 110, the character recognition circuit 120, the post-processing circuit 130, the V2S conversion circuit 140, the audio output module 10A, etc.

In the above embodiments, examples of the video source device may include, but are not limited to: a personal computer such as a desktop computer and a laptop computer.

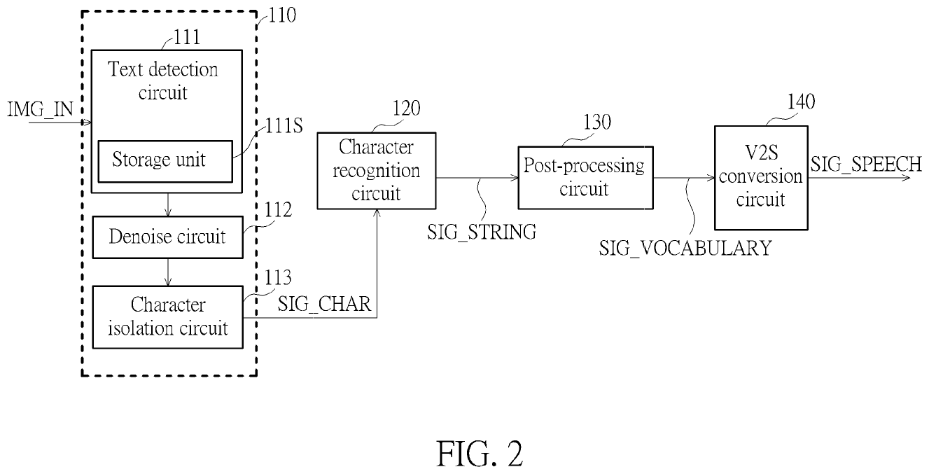

FIG. 2 illustrates a real-time multi-processing control scheme of a method for performing real-time video content text detection and speech automatic generation in a display device such as the display device shown in FIG. 1 according to an embodiment of the present invention, wherein the method can be applied to the display device 10 shown in FIG. 1 and the display control IC 100 therein. The image processing circuit 101 can perform signal pre-processing such as the above-mentioned video pre-processing operations on the input video signal to generate a video signal IMG_IN for performing the associated operations of the at least one additional function, but the present invention is not limited thereto. According to some embodiments, when the video format of the input video signal is suitable for being directly used in these operations, the image processing circuit 101 can bypass the input video signal as the video signal IMG_IN. In addition, the preprocessing circuit 110 may comprise a text detection circuit 111, a denoise circuit 112 and a character isolation circuit 113, and the text detection circuit 111 may comprise a storage unit 111S, which can be taken as an example of the above-mentioned storage unit. For better comprehension, the arrows between the components in the architecture shown in FIG. 2 may indicate certain data flows, but the present invention is not limited thereto. For example, the text detection circuit 111, the denoise circuit 112, the character isolation circuit 113, the character recognition circuit 120, etc. may share the storage unit 1115. For another example, when there is a need, any component of the components in the architecture can communicate with another component of these components.

The preprocessing circuit 110 can receive the video signal IMG_IN to obtain a real-time video content carried by the video signal IMG_IN, and perform preliminary text detection on the real-time video content to generate a series of segmented character images to indicate a subtitle in the real-time video content, and send the series of segmented character images to the character recognition circuit 120 through a segmented character image signal SIG CHAR. The storage unit 1115 can store a partial image of the real-time video content for performing the preliminary text detection, where the partial image may correspond to more than one row of pixel data, such as a predetermined number of rows of pixel data. For example, the text detection circuit 111 can perform the preliminary text detection according to the real-time video content, and more particularly, can perform image filtering on the real-time video content to generate a filtered image, search for a text region having multiple lines in the filtered image to be a target region, and obtain at least one text-existence image (e.g., one or more text-existence images) in the target region for further processing. The denoise circuit 112 can perform denoising processing on the at least one text-existence image to generate at least one denoised text image (e.g., one or more denoised text images), where the denoising processing can remove the noise in the image and keep important information to prevent possible errors in subsequent processing. The character isolation circuit 113 can perform character isolation on the at least one denoised text image to segment the at least one denoised text image into the series of segmented character images. In addition, the character recognition circuit 120 can perform character recognition on the series of segmented character images to generate a series of characters corresponding to the subtitle, respectively, and send the series of characters to the post-processing circuit 130 through a string signal SIG_STRING. Since the denoise circuit 112 has performed the denoising processing in advance, the accuracy of the character recognition performed by the character recognition circuit 120 can be greatly enhanced. The post-processing circuit 130 can perform vocabulary correction on the series of characters to selectively replace any erroneous character with a correct character to generate one or more vocabularies for performing speech automatic generation, and more particularly, send the one or more vocabularies such as the set of vocabularies to the V2S conversion circuit 140 through a vocabulary signal SIG_VOCABULARY for performing speech automatic generation. Additionally, the V2S conversion circuit 140 can perform V2S conversion on the one or more vocabularies such as the set of vocabularies to generate an audio signal corresponding to the one or more vocabularies, such as the speech signal SIG_SPEECH, for performing speech output. For example, the V2S conversion circuit 140 may comprise a waveform generator (not shown in figure), and utilize the waveform generator to generate speech according to the one or more vocabularies, but the present invention is not limited thereto.

In the above embodiments, the storage unit 1115 can be implemented by way of a line buffer, etc.

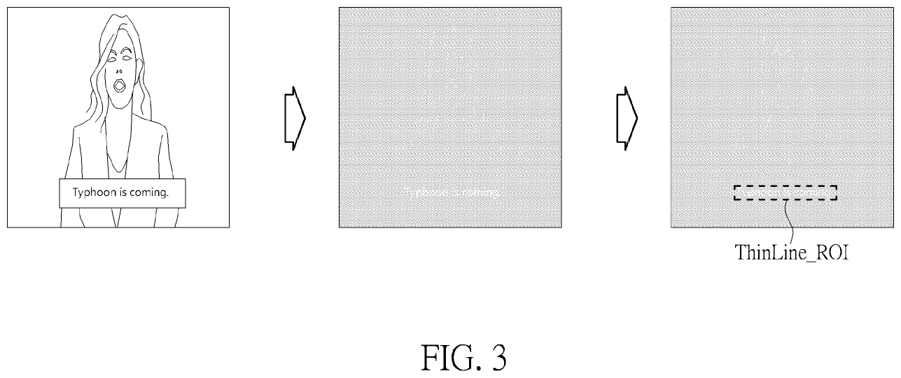

FIG. 3 illustrates an image filtering and target region control scheme of the method according to an embodiment of the present invention. The picture shown in the leftmost part of FIG. 3 can be taken as an example of the above-mentioned real-time video content, the picture shown in the central part of FIG. 3 can be taken as an example of the filtered image, and the target region ThinLine_ROI in the picture shown in the rightmost part of FIG. 3 and the text-existence image in the target region ThinLine_ROI can be taken as examples of the above-mentioned target region and the at least one text-existence image in the target region, respectively. Since the text detection circuit 111 can perform line detection such as thin-line detection (TLD) to determine the existence of the multiple lines (e.g., the strokes of the text in the text-existence image) to determine the target region ThinLine_ROI, the target region ThinLine_ROI can be regarded as a TLD-based region of interest (ROI). Basically, the region of interest corresponds to at least one subtitle in the real-time video content. For brevity, similar descriptions for this embodiment are not repeated in detail here.

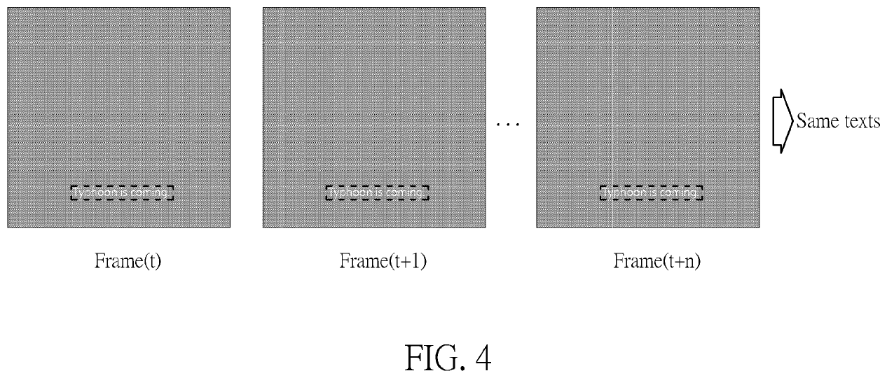

FIG. 4 illustrates a redundant-processing prevention control scheme of the method according to an embodiment of the present invention. The aforementioned real-time video content carried by the video signal IMG_IN may represent the video content carried by any frame of multiple frames of the video signal IMG_IN, such as a picture corresponding to the any frame of the multiple frames. The multiple frames may comprise frames Frame(0), Frame(1), etc., and a series of consecutive frames in the multiple frames may comprise frames Frame(t)-Frame(t+n), where the symbol “t” can represent a time index corresponding to time, and the symbol “n” can represent a positive integer. The text detection circuit 111 can monitor whether the at least one text-existence image appears in the respective filtered images of the series of consecutive frames (e.g., the frames Frame(t)-Frame(t+n)), to prevent triggering repeated processing regarding the at least one text-existence image (such as repeated processing in the case of the same subtitle that appears multiple times in consecutive frames). For example, the frames Frame(t)-Frame(t+n) can have the same subtitle text image. The text detection circuit 111 can control the pre-processing circuit 110 to prevent redundant processing, and more particularly, can control the architecture shown in FIG. 2 to prevent redundant processing.

For better comprehension, assuming that n>1, the series of consecutive frames may comprise frames Frame(t), Frame(t+1) . . . and Frame (t+n) . The text detection circuit 111 can perform the preliminary text detection regarding the frame Frame(t) to determine the target region ThinLine_ROI and the text-existence image therein, and, when performing the preliminary text detection regarding the frames Frame(t+1)-Frame(t+n), detect that the same target region ThinLine ROI and the same text-existence image exist in the respective filtered images of the frames Frame (t) -Frame (t+n), which can indicate that:

(1) the same string (e.g., the same word) exists in the frames Frame(t)-Frame(t+n); and
(2) the subsequent processing regarding the frames Frame(t+1)-Frame(t+n) belongs to redundant processing and is unnecessary;
wherein, the text detection circuit 111 can prevent repeatedly outputting the same text-existence images in the same target region ThinLine_ROI to the denoise circuit 112, in order to control the architecture shown in FIG. 2 to prevent redundant processing. As a result, the display control IC 100 (e.g., the text detection circuit 111) can reduce or eliminate the discontinuity of the speech output result, and more particularly, can ensure that a complete sentence is generated and output, and prevent the same sentence from being repeatedly generated and output. For brevity, similar descriptions for this embodiment are not repeated in detail here.

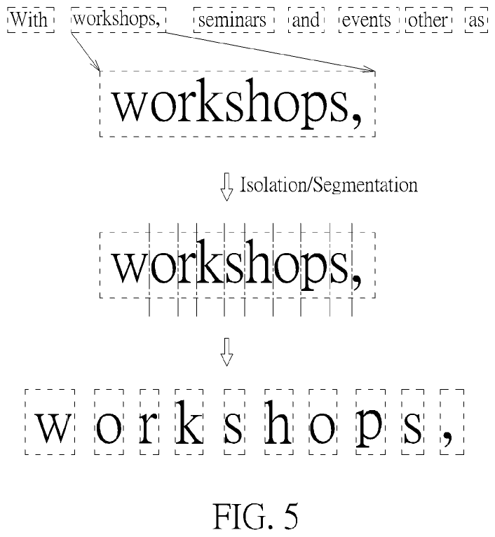

FIG. 5 illustrates a character image isolation/segmentation control scheme of the method according to an embodiment of the present invention. The multiple text images shown in the uppermost part of FIG. 5 (e.g., the text images having the English texts “With”, “workshops,”, “seminars”, “and”, “events”, “other” and “as” respectively) can be taken as an example of the above-mentioned at least one denoised text image, and the multiple segmented character images shown in the lowermost part of FIG. 5 (e.g., the character images having the characters “w”, “o”, “r”, “k”, “s”, “h”, “o”, “p”, “s” and “,” respectively) can be taken as examples of the series of segmented character images. The character isolation circuit 113 can perform character isolation/segmentation on the at least one denoised text image such as the text image having the text “workshops,” to obtain the series of segmented character images such as the character images having the characters “w”, “o”, “r”, “k”, “s”, “h”, “o”, “p”, “s” and “,” respectively. As a result, the display control IC 100 (e.g., the character isolation circuit 113) can reduce the difficulty of the character recognition, and more particularly, enhance the accuracy of the character recognition. For brevity, similar descriptions for this embodiment are not repeated in detail here.

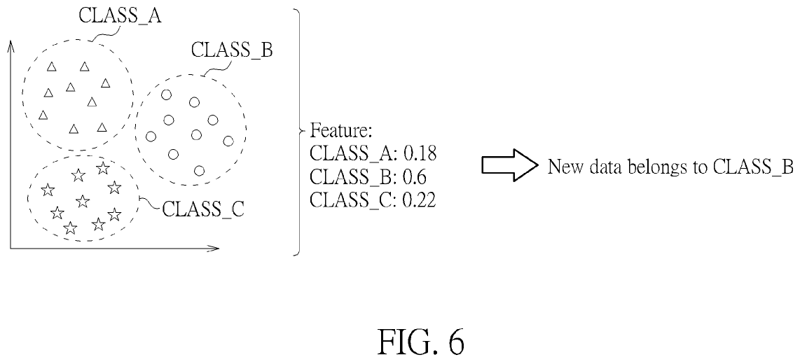

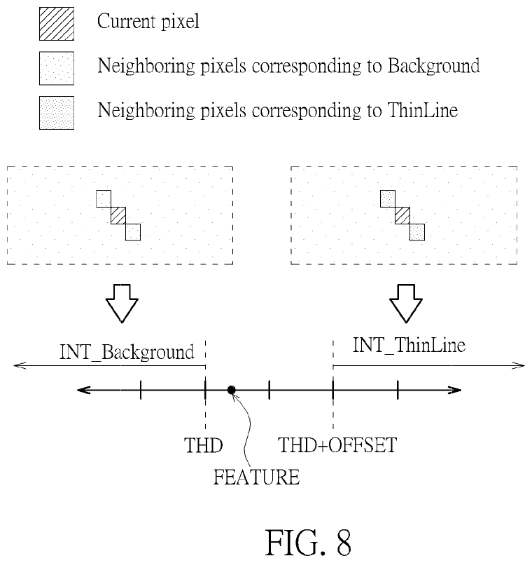

FIG. 6 illustrates a character classification and recognition control scheme of the method according to an embodiment of the present invention. According to any predetermined character data set among multiple predetermined character data sets, the character recognition circuit 120 can determine the similarity between the series of segmented character images and the any predetermined character data set, in order to recognize the series of characters from the series of segmented character images. More particularly, the multiple predetermined character data sets may represent respective known data sets of multiple predetermined classes. Based on the multiple predetermined classes such as classes CLASS_A, CLASS_B, CLASS_C, etc., the character recognition circuit 120 can perform the character recognition on any segmented character image of the series of segmented character images to generate a corresponding character of the series of characters, for example, by determining the similarity between the any segmented character image and the above-mentioned respective known data sets of the multiple predetermined classes, where the above-mentioned respective known data sets of the multiple predetermined classes may comprise respective characteristic values of respective sets of character images of multiple predetermined characters. In supervised learning, all data belong to labeled data. When receiving the any segmented character image, the character recognition circuit 120 can extract the feature value FEATURE (e.g., as shown in FIG. 8) of the any segmented character image, and check the similarities between the feature value FEATURE and the feature values in the labeled data sets, respectively, to determine the corresponding character. For example, regarding the similarity check results for the classes CLASS_A, CLASS_B and CLASS_C being 0.18, 0.6 and 0.22, respectively, this indicates that the similarity between the any segmented character image and the class CLASS_B is the greatest (in comparison with the similarity between the any segmented character image and any of the remaining classes), so the character recognition circuit 120 can determine that the new data belongs to the class CLASS_B. For brevity, similar descriptions for this embodiment are not repeated in detail here.

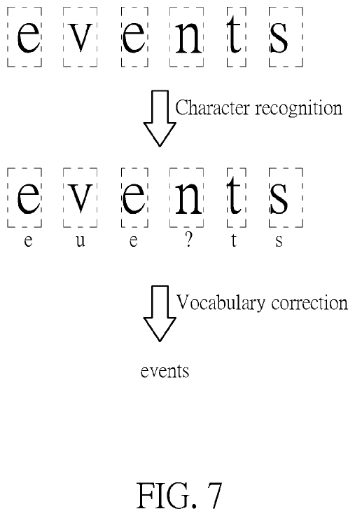

FIG. 7 illustrates a vocabulary correction control scheme of the method according to an embodiment of the present invention. The set of segmented character images shown in the uppermost part of FIG. 7 (e.g., the character images having the characters “e”, “v”, “e”, “n”, “t” and “s” respectively) can be taken as examples of the series of segmented character images, and the “eue?ts” (labeled under the same set of segmented character images, respectively) shown in the central part of FIG. 7 can represent the corresponding character recognition results such as the series of characters, and the correct vocabulary “events” shown in the lowermost part of FIG. 7 can be taken as an example of the one or more vocabularies, where the symbol “?” in this embodiment can represent an unrecognized character.

The post-processing circuit 130 can determine whether the any erroneous character exists according to a predetermined vocabulary data set, for selectively replacing the any erroneous character with the correct character. Assuming that the series of characters represent the vocabulary “events”, the post-processing circuit 130 can detect that this vocabulary “events” matches the vocabulary “events” in the predetermined vocabulary data set, and therefore determines that there is no erroneous character (i.e., the any erroneous character does not exist) . As shown in FIG. 7, in a situation where the series of characters represent “euets” (and there is an unrecognized character between the second “e” and “t”), the post-processing circuit 130 can detect that “euets” does not belong to any known vocabulary of the predetermined vocabulary data sets, and therefore determine that the any erroneous character exists. The post-processing circuit 130 can respectively compare all vocabularies in the predetermined vocabulary data set with the series of characters according to a predetermined vocabulary correction algorithm, to automatically correct the series of characters such as “euets” to be the correct vocabulary “events”. For brevity, similar descriptions for this embodiment are not repeated in detail here.

FIG. 8 illustrates a pixel-based line and background detection control scheme of the method according to an embodiment of the present invention. The text detection circuit 111 can calculate the respective feature values {FEATURE} of a current pixel and multiple neighboring pixels, and according to whether the respective feature values { FEATURE} of the current pixel and the multiple neighboring pixels fall within a background interval INT_Background or a line interval INT_ThinLine among multiple predetermined intervals, determine whether the current pixel and the multiple neighboring pixels belong to the background or any line of the multiple lines, wherein the background interval INT_Background and the line interval INT_ThinLine can be defined by at least one threshold (e.g., one or more thresholds) such as the threshold THD. Taking the current pixel as an example, if the feature value FEATURE of the current pixel falls within the background interval INT_Background, which may indicate that the current pixel has a higher probability of belonging to the background, the text detection circuit 111 can determine that the current pixel belongs to the background. If the feature value FEATURE of the current pixel falls within the line interval INT_ThinLine, which can indicate that the current pixel has a higher probability of belonging to a line such as a thin line, the text detection circuit 111 can determine that the current pixel belongs to the any line of the multiple lines.

As shown in FIG. 8, The background interval INT_Background and the line interval INT_ThinLine can be equivalent to the interval (−∞, THD] and the interval [(THD+OFFSET), ∞), respectively, where the symbol “OFFSET” can represent an offset value. The sum (THD+OFFSET) of the threshold THD and the offset value OFFSET can be regarded as another threshold that is different from the threshold THD, so the other threshold such as the sum (THD+OFFSET) can be taken as an example of the at least one threshold. For brevity, similar descriptions for this embodiment are not repeated in detail here.

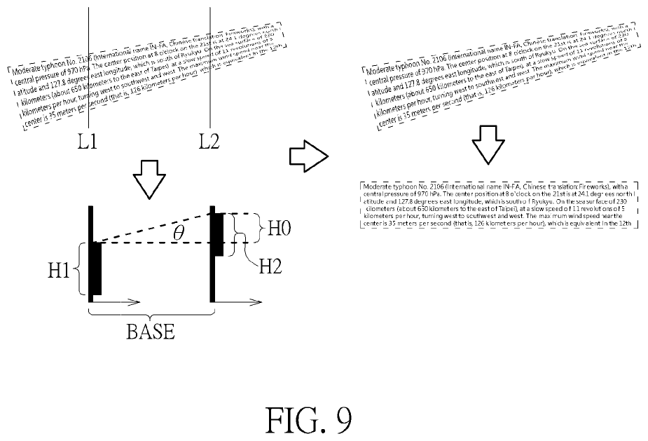

FIG. 9 illustrates a text image pre-processing control scheme of the method according to an embodiment of the present invention. The text detection circuit 111 can perform text image pre-processing, and more particularly, detect whether the at least one text-existence image in the target region needs tilt correction and/or keystone correction, to selectively perform these corrections. As shown in FIG. 9, the text detection circuit 111 can perform pixel detection on the at least one text-existence image along vertical reference lines L1 and L2 to determine parameters H0, H1 and H2, where the parameters H1 and H2 can respectively represent the ranges of the thin line distributions detected along the vertical reference lines L1 and L2, and the parameter H0 can represent the offset along the vertical direction. Given that the parameter BASE represents a predetermined distance such as the distance between the vertical reference lines L1 and L2, the text detection circuit 111 can calculate a tilt angle el of the at least one text-existence image according to the parameters BASE and H0. The text detection circuit 111 can perform associated calculations according to the parameters BASE, H0, H1 and H2 and the tilt angle θto perform the text image pre-processing such as the tilt correction, the keystone correction, etc. For brevity, similar descriptions for this embodiment are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display control integrated circuit (IC), applicable to performing real-time video content text detection and speech automatic generation in a display device, the display control IC comprising:
a pre-processing circuit, configured to input a video signal to obtain a real-time video content carried by the video signal, and perform preliminary text detection on the real-time video content to generate a series of segmented character images to indicate a subtitle;
a character recognition circuit, coupled to the pre-processing circuit, configured to perform character recognition on the series of segmented character images to generate a series of characters corresponding to the subtitle, respectively; and
a post-processing circuit, coupled to the character recognition circuit, configured to perform vocabulary correction on the series of characters to selectively replace any erroneous character with a correct character to generate one or more vocabularies, for performing speech automatic generation.

2. The display control IC of claim 1, further comprising:
a storage unit, configured to store a partial image of the real-time video content for performing the preliminary text detection, wherein the partial image corresponds to more than one row of pixel data.

3. The display control IC of claim 2, wherein the display control IC comprises multiple sub-circuits, and the multiple sub-circuits comprise the pre-processing circuit, the character recognition circuit and the post-processing circuit; and the storage unit is integrated into one of the multiple sub-circuits.

4. The display control IC of claim 1, wherein the pre-processing circuit further comprises:
a text detection circuit, configured to perform the preliminary text detection according to the real-time video content, wherein the text detection circuit performs image filtering on the real-time video content to generate a filtered image, and searches for a text region having multiple lines in the filtered image to be a target region, and obtain at least one text-existence image in the target region for further processing.

5. The display control IC of claim 4, wherein the pre-processing circuit further comprises:
a denoise circuit, coupled to the text detection circuit, configured to perform denoising processing on the at least one text-existence image to generate at least one denoised text image; and
a character isolation circuit, coupled to the denoise circuit, configured to perform character isolation on the at least one denoised text image to segment the at least one denoised text image into the series of segmented character images.

6. The display control IC of claim 4, wherein the text detection circuit monitors whether the at least one text-existence image appears in the respective filtered images of a series of continuous frames, in order to prevent triggering repeated processing regarding the at least one text-existence image.

7. The display control IC of claim 4, wherein the text detection circuit calculates respective characteristic values of a current pixel and multiple neighboring pixels, and determines, according to whether the respective characteristic values of the current pixel and the multiple neighboring pixels fall within a background interval or a line interval among multiple predetermined intervals, whether the current pixel and the multiple neighboring pixels belong to the background or any line of the multiple lines, wherein the background interval and the line interval are defined by at least one threshold.

8. The display control IC of claim 1, wherein according to any predetermined character data set among multiple predetermined character data sets, the character recognition circuit determines similarity between the series of segmented character images and the any predetermined character data set, in order to recognize the series of characters from the series of segmented character images.

9. The display control IC of claim 1, wherein the post-processing circuit determines whether the any erroneous character exists according to a predetermined vocabulary data set, for selectively replacing the any erroneous character with the correct character.

10. The display control IC of claim 1, further comprising:
a vocabulary-to-speech conversion circuit, coupled to the post-processing circuit, configured to perform vocabulary-to-speech conversion on the one or more vocabularies to generate an audio signal corresponding to the one or more vocabularies for outputting speech.
